(19) United States
(12) Patent Application Publication
(10) Pub. No.: US 2007/0117486 A1
(43) Pub. Date: May 24, 2007

(54) Fibreglass yarn-based woven cloth for reinforcing moulded parts

(75) Inventor: Michel Serillon, Mariac (FR)

Correspondence Address: HESLIN ROTHENBERG FARLEY & MESITI PC, 5 COLUMBIA CIRCLE, ALBANY, NY, 12203, US

(73) Assignee: Chomarat Composites, Paris (FR)

(21) Appl. No.: 10/581,289

(22) PCT Filed: Dec. 6, 2004
(86) PCT No.: PCT/FR04/50658

§ 371 Date: Jun. 1, 2006

(30) Foreign Application Priority Data
Dec. 18, 2003 (FR) 0351100

(51) Int. Cl. B32B 5/02; D03D 13/00; B32B 17/02

(52) U.S. Cl. 442/203; 442/172; 442/180

(57) ABSTRACT

A woven cloth based on high-strength yarns, in particular fiberglass yarns, is used for reinforcing parts moulded by resin transfer moulding (RTM) and comprises threads which are disposed in a weft direction and are not perpendicular to warp threads. Said woven cloth is characterised in that a ratio T_{c}D_{c}/TₜDₜ ranges from 0.2 to 0.8, wherein T_{c} is a warp thread number, Tₜ is weft tread number, D_{c} is the number of warp threads per length unit and Dₜ is the number of weft threads per length unit.

### FIELD OF THE INVENTION

The invention relates to the field of technical textiles. More precisely, it concerns the textiles used to form reinforcing parts for mouldings produced by moulding, more precisely using Resin Transfer Moulding (RTM) techniques.

The invention relates more precisely to the production of multi-axial reinforcing parts, i.e. reinforcing parts having threads oriented in at least three directions.

### Description of the Prior ART

Generally speaking, parts obtained by using RTM have a mechanical strength that is defined by the structure of an integral textile reinforcing part. This is why it is preferable to use so-called “multi-axial” reinforcing parts, i.e. those that have at least three preferred strength directions. In fact, such reinforcing parts confer better rigidity than unidirectional or even bidirectional reinforcing parts made by weaving perpendicular warp and weft threads.

Currently, several types of multi-axial reinforcing parts have been suggested. In particular, the Applicant's Document EP 0,193,479 discloses woven cloths comprising non-perpendicular warp and weft threads. The non-perpendicular inclination of the warp and weft threads is obtained by offset winding on the outlet of the shuttle loom. In order for these operations to be possible, it is generally necessary for the warp thread to be especially fine compared to the weft threads in order to allow deformation of the cloth before it is wound. It is then possible to combine the strengthening directions by superimposing two layers of these cloths, arranging the weft threads symmetrically relative to the common direction of the warp threads. This assembly is then associated with the cloth comprising the heavier warp threads in order to obtain a 3-directional reinforcing part. Assembly of these various layers can be obtained by sewing or bonding.

However, this type of reinforcing part has certain disadvantages. In fact, in order to produce 3-directional reinforcing parts, it is necessary to assemble three different layers and this makes fabrication relatively time-consuming and therefore expensive. The reinforcing part obtained also has a relatively large thickness which may disrupt subsequent moulding operations, especially because of resin diffusion problems. Also, the reinforcing part thus obtained therefore comprises a plurality of layers which each contribute to its mechanical strength along a given axis. In other words, the direction of rigidity is not homogeneous throughout the thickness of the reinforcing part.

In addition, other types of reinforcing parts produced using known techniques are referred to as “crossply”. These cloths are obtained by superimposing two sets of yarns that can have similar thread numbers and are arranged by multidirectional pirn winders. These various sets of yarns which are not entangled but simply superimposed are then joined to each other by sewing operations using techniques referred to as Malimo. These so-called crossply reinforcing parts are useful in that they contain threads having different orientations which are associated by a single sewing operation. Nevertheless, the fact that these various layers are placed one above the other means that the orientation of rigidity is not homogenous throughout the thickness of the reinforcing part. In addition and in particular, sewing the various layers together significantly restricts the deformability of the reinforcing part and therefore prevents it being used in order to produce parts having a complex geometry or, more generally, parts that include significant breaks in slope.

In addition, Document U.S. Pat. No. 4,055,697 discloses a reinforcing part based on cloth, the weft threads of which have a non-perpendicular orientation relative to the weft threads. This type of reinforcing part intended to improve mechanical properties in predetermined directions is not satisfactory in terms of deformability.

One of the objects of this invention is to provide a reinforcing part for RTM mouldings that can be produced in a limited number of fabrication stages. Another object is to obtain a reinforcing part that has multi-axial rigidity distributed throughout the reinforcing part. Another object is to make it possible to obtain reinforcing parts having a high basis weight without increasing the number of layers required to achieve this. Another object of the invention is to obtain reinforcing parts that combine both a high stiffening capacity and good deformability during subsequent moulding operations.

### SUMMARY OF THE INVENTION

The invention therefore relates to a woven cloth based on fibreglass yarns or, more generally, high-tenacity yarns such as aramid or carbon yarns which is used for reinforcing parts moulded by Resin Transfer Moulding (RTM). This woven cloth comprises, in the weft direction, threads that are not perpendicular to the warp threads.

In accordance with the invention, this cloth is characterised in that the ratio T_{c}·D_{c}/Tₜ·Dₜ ranges from 0.2 to 0.8, where:

T_{c} is the warp thread number (linear density),

Tₜ is the weft thread number (linear density),

D_{c} is the number of warp threads per unit length,

Dₜ is the number of weft threads per unit length.

In other words, the invention involves using, in order to form reinforcing parts, woven cloths which, in contrast to the prior art, comprise warp threads having a relatively high thread number (linear density). In this way, it has been found that it is possible to produce cloths by weaving that include not only weft threads but also warp threads having a high thread number (linear density).

In other words, the cloth according to the invention comprises, in the warp direction, threads that account for 15 to 45% of the basis weight of the cloth layer in question. This represents a much higher proportion than that observed in woven cloths with weft and warp threads that are not perpendicular, such as the cloth described in Patent EP 193,479. Despite conventional wisdom, it has been observed that it is possible to deform such a cloth at the output of the shuttle loom in order to obtain a non-perpendicular inclination between the warp threads and weft threads.

This deformation can be facilitated by certain weave patterns, especially in cases where weaves in the twill family are used, especially 2/2 twills or 3/1 twills.

In this way it is possible to produce reinforcing parts by associating at least two cloth layers as described above and placing them one above the other. These two layers are associated so that the warp threads of these two layers are parallel, the weft threads then having a symmetrical inclination relative to the direction of the warp threads from one layer to the next. In this way one obtains a reinforcing part that has significant rigidity in at least three directions. It is important to note that the warp threads of the two superimposed layers each contribute to the mechanical strength in the warp direction. In other words, each of the layers contributes to the overall strength in the warp direction. In other words, the mechanical strength in the warp direction is distributed throughout the thickness of the reinforcing part.

Similarly, in contrast to crossply-type structures, the threads oriented in three directions are accessible on the outer faces of the reinforcing part and can therefore hold resin during moulding.

In practice, it is possible to associate a variable number of layers depending on the type of reinforcing part that one wishes to produce. Thus, it is possible to associate two superimposed layers in which the inclination of the weft threads relative to the warp threads is approximately 60°. In this case, the ratio T_{c}·D_{c}/Tₜ·Dₜ defined above substantially ranges from 0.3 to 0.8. It is preferably approximately 0.5. In other words, in each of the elementary layers of the reinforcing part, the warp accounts for substantially 25 to 45% of the overall basis weight of the elementary layer and preferably accounts for a third of this basis weight. When two elementary layers are associated in order to form the overall reinforcing part, each of the layers contributes half the strength in the warp direction. The basis weight of the warp threads and the weft threads in each of the directions 60° apart are therefore substantially identical.

It is also possible to associate three elementary layers in order to form a 4-directional reinforcing part. In this case, the two external layers have weft threads that are inclined relative to the warp threads. These two external layers sandwich a woven cloth layer in which the warp threads and weft threads are perpendicular. In this case, each of the external layers has a ratio T_{c}·D_{c}/Tₜ·Dₜ as defined above of 0.2 to 0.8 and substantially approximately 0.33. In terms of the overall basis weight of an elementary layer, this is equivalent to stating that the warp accounts for 15 to 45% and preferably approximately 25%. Thus, if the external layers have weft threads oriented at 45°, this produces a symmetrical 4-directional reinforcing part. The three layers thus associated advantageously contribute roughly a third of the overall rigidity of the reinforcing part.

In practice, layers can be assembled to form these reinforcing parts in different ways, especially by sewing or bonding. In the preferred case of bonding, ideally one uses a material having the same chemical nature as that used in the moulding process as a bonding agent. In fact, in this case, the deformability of the reinforcing part is optimised because, during moulding, the bonding agent softens and allows displacement of the various layers relative to each other.

### BRIEF DESCRIPTION OF THE DRAWINGS

The way in which the invention is embodied and its resulting advantages will become more apparent from the description of the embodiment which follows, reference being made to the accompanying drawings in which:

FIG. 1 is a top view of an elementary layer produced in accordance with the invention.

FIG. 2 is a top view of a reinforcing part formed by two layers similar to that in FIG. 1.

FIG. 3 is a similar view of a reinforcing part incorporating three layers with the external layers being similar to those in FIG. 1.

### DESCRIPTION OF THE PREFERRED EMBODIMENTS

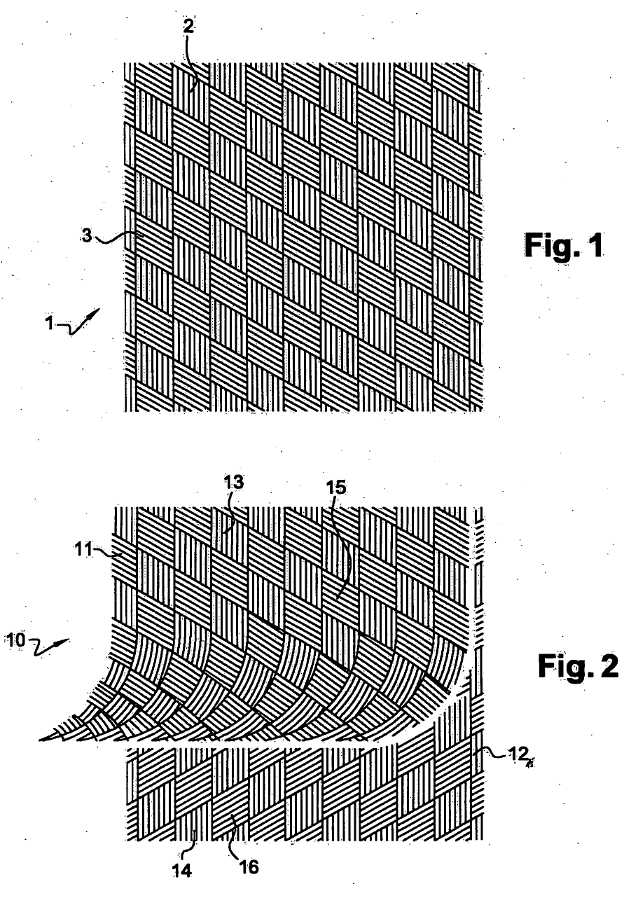

The cloth shown in FIG. 1 illustrates a cloth (1) produced by weaving warp threads (2) and weft threads (3) based on fibreglass yarns. In practice, the yarns (or roving) (2) used for the warp threads have a thread number from 300 to 2400 tex. There are 0.5 to 2 threads/cm. In the weft direction, the threads (or roving) (3) used have a larger thread number, typically of the order of 600 to 4800 tex. There are roughly 0.4 to 2.5 threads/cm. In practice, the number of threads per centimetre is stated before deformation and the observed values on sets of threads obtained after deformation are deduced by trigonometric equations, depending on the angle of inclination.

In the example shown in FIG. 1, the warp threads and weft threads form an angle of 60° relative to each other, but this inclination may be different and is selected depending on the number of layers associated in order to form a reinforcing part.

Thus, in the example shown in FIG. 2, the reinforcing part (10) comprises two similar associated layers. These two layers (11, 12) are joined so that the directions of their warp threads (13, 14) are absolutely identical (and therefore at 0° to the direction of the warp threads in question as the reference direction). In this way, the weft threads (15) of the upper layer (11) (−60° to the reference direction) are symmetrical with the weft threads (16) of the lower layer (12) (+60° to the reference direction) relative to the warp direction (13, 14). The assembly thus produced has a symmetrical 3-axial structure in three directions that are offset from each other by 60°.

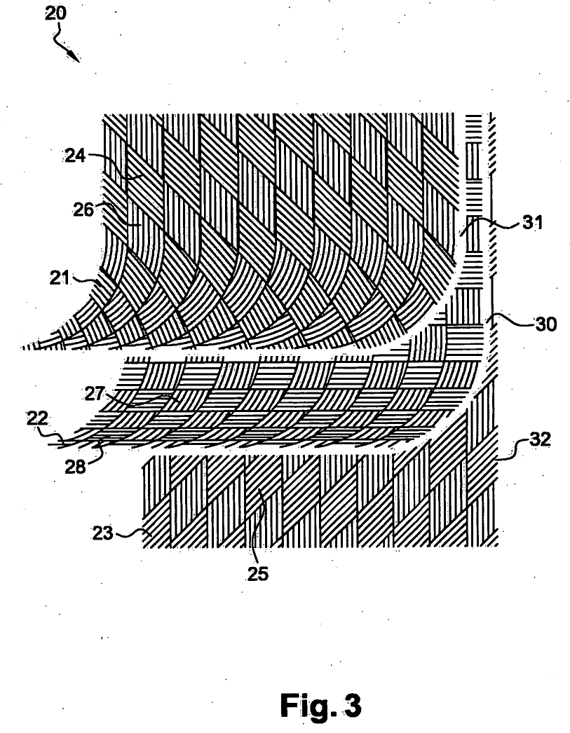

FIG. 3. shows another embodiment of a reinforcing part formed by three different layers (21, 22, 23). The external layers (21, 23) are formed by weaving warp and weft threads at an angle of 45° to each other. These two layers (21, 23) are oriented so that the weft threads (24) (−45° to the reference direction) of the upper layer (21) are symmetrical with the weft threads (25) (+45° to the reference direction) of the lower layer (23) relative to the common direction of the warp threads (26). These two layers (21, 23) are separated by an intermediate layer (22) formed by conventional weaving, i.e. warp (27) and weft (28) at right angles (0° and 90° to the reference direction).

In a special embodiment, the warp threads (26) of the upper layer (21) have a thread number of 1200 tex and there are 2.55 threads/cm. In this way, the warp threads (26) of the upper layer have a basis weight of approximately 305 g/m². The weft threads (24) have a thread number of 4800 tex and a density of 1.90 threads/cm, this therefore accounting for a basis weight of the order of 916 g/m². The warp threads (26) therefore account for substantially a quarter of the basis weight of the upper layer (21). The lower layer (23) has the same composition as the upper layer (21) but is oriented symmetrically at an opposite angle of 45°.

The intermediate layer (22) comprises warp threads (27) having a thread number of 1200 tex with a density of 2.50 threads/cm which is equivalent to a warp basis weight of the order of 300 g/m². The weft threads (28) have a thread number of 4800 tex and there are 1.90 threads/cm which is equivalent to a basis weight of 912 g/m².

The various layers (21, 22, 23) are associated with each other by films of bonding agent (30, 31), typically based on epoxy resin powder or polyester resin powder applied up to a rate of 5 g/m² per layer. The external face or faces of the reinforcing part can also accommodate the same resin as the layers (30, 31), thus enabling possible hot pressure bonding with other reinforcing parts.

The overall reinforcing part (20) has a basis weight of the order of 3600 g/m². The basis weight is substantially 910 g/m² for the threads oriented at 0°, +45°, +90° and −45° relative to the direction of the warp threads. Note that the threads parallel to the warp direction are distributed over the three layers of the reinforcing part.

It is apparent from the above descriptions that the invention has the advantage of having several preferred directions of rigidity although the number of layers required is less than that necessary in solutions according to the prior art. It is also highly deformable, especially during preforming at high temperature: in fact, softening by heating (to temperatures of the order of 120° C.) the bonding resin between the layers makes it possible for the layers of the reinforcing part to slide relative to each other and each layer is capable of deforming individually and this ensures that the entire reinforcing part is easily deformable.

1. A woven cloth based on high-tenacity yarns, used for reinforcing parts obtained by Resin Transfer Moulding (RTM) and comprising weft threads which are arranged in a weft direction and are not perpendicular to warp threads,
wherein a ratio T_{c}·D_{c}/Tₜ·Dₜ ranges from 0.2 to 0.8 where:
T_{c} is warp thread number (linear density),
Tₜ is weft thread number (linear density),
D_{c} is number of warp threads per length unit,
Dₜ is number of weft threads per length unit.

2. A woven cloth as claimed in claim 1, wherein inclination of the weft threads relative to the warp threads is from 30 to 80°.

3. A woven cloth as claimed in claim 1, having a weave of the twill type.

4. A reinforcing part formed by at least two textile layers of the woven cloth of of claims 1, placed one above the other, wherein the warp threads are parallel from one layer to the other and the weft threads have a symmetrical inclination relative to a direction of the warp threads from one layer to the other.

5. A reinforcing part as claimed in claim 4, comprises comprising two layers placed one above the other, each of the two layers has a ratio T_{c}·D_{c}/Tₜ·Dₜ of 0.3 to 0.8.

6. A reinforcing part as claimed in claim 5, wherein the inclination of the weft threads relative to direction of the warp threads is approximately 60°.

7. A reinforcing part as claimed in claim 4, further comprising a layer of woven cloth based on fiberglass yarns with perpendicular warp and weft threads, each of the layers of the reinforcing part having a ratio of T_{c}·D_{c}/Tₜ·Dₜ of 0.2 to 0.8.

8. A reinforcing part as claimed in claim 7, wherein said inclination comprises approximately 45°.

9. A reinforcing part as claimed in claim 4, wherein the layers are assembled by bonding.

10. A reinforcing part as claimed in claim 9, wherein the bonding is obtained using a material having a same chemical nature as that used in the moulding.

11. The woven cloth as claimed in claim 1, wherein the yarns comprise fiberglass yarns.

12. The woven cloth as claimed in claim 3, wherein the weave comprises a 2/2 twill.

13. The woven cloth of claim 5, wherein each of the two layers has a ratio T_{c}·D_{c}/Tₜ·Dₜ of approximately 0.5.

14. The reinforcing part as claimed in claim 7, wherein each of the layers of the reinforcing part has a ratio T_{c}·D_{c}/Tₜ·Dₜ of approximately 0.33.
